(19) United States
(12) Patent Application Publication
(10) Pub. No.: US 2023/0117762 A1
(43) Pub. Date: Apr. 20, 2023

(54) CONTEXT MODELING FOR AN ONLINE CONCIERGE SYSTEM

(71) Applicant: Maplebear Inc. (dba Instacart), San Francisco, CA (US)

(72) Inventors: Manmeet Singh, Santa Clara, CA (US); Tejaswi Tenneti, Fremont, CA (US)

(21) Appl. No.: 17/503,245

(22) Filed: Oct. 15, 2021

(51) Int. Cl. G06Q 30/06; G06N 3/02

(52) U.S. Cl. CPC G06Q 30/0631; G06N 3/02

(57) ABSTRACT

An online concierge system improves on methods for presenting content to users. The online concierge system generates a user embedding for a user and recipe embeddings for candidate recipes. The online concierge system generates a context embedding by applying a context embedding model to context data received from a user mobile application. The online concierge system calculates an overall score for each candidate recipe based on a user score and a context score. The user score is calculated based on the user embedding and a recipe embedding for the candidate recipe. The context score is calculated based on the generated context embedding and the recipe embedding for the candidate recipe. The online system selects a recipe for presentation to the user based on the overall scores. The online concierge system trains the context embedding model using a loss function that is based on the user score and the context score.

### BACKGROUND

Online systems, like online concierge systems, often present content to users with which the user interacts. At times, developers of online systems create new features that allow the online system to present new kinds of content to users with which the user has not previously interacted. Oftentimes, these online systems use pre-existing models for user engagement and interest to determine what of the new content the online system should present to the user. However, because these pre-existing models have been trained on data generated before the new feature was developed, these models often fail to accurately assess what of the new content a user will want to engage with. This is because long-term data about a user's interests in old types of content does not track as well with the new content available through the online system's new feature.

Furthermore, users of an online system may have different interests in a particular session of using the online system from their typical, long-term interests. For example, if a user historically uses an online concierge system to order ingredients for tomato sauce, the online concierge system may erroneously suggest ingredients for the tomato sauce during a session in which the user searches for ingredients for gazpacho. Thus, conventional online systems miss opportunities to increase user engagement with content when only considering long-term user data, and insufficiently considering context data.

### SUMMARY

An online concierge system provides improved content presentation to a user through the user of a context embedding model. The online concierge system receives user data from a user using a user mobile application and generates a user embedding based on the user data. Additionally, the online concierge system generates recipe embeddings for recipes that the online concierge system may present to the user. To generate the recipe embeddings, the online concierge system may generate product embeddings for products that are associated with the recipe. The online concierge system may then generate a recipe embedding for the recipe based on the product embeddings.

To select a recipe to present to a user, the online concierge system selects a set of candidate recipes out of the recipes stored by the online concierge system. The online concierge system selects the set of candidate recipes based on context data describing the user's current session with the online concierge system. The context data may include search data by the user, data on how long the user has been in the current session, and data describing the user's engagement with search results that have been presented to the user during the session. Additionally, the context data may include information about a selected products list for the user's current session. The selected products list may include one or more products that the user has selected to eventually order via the online concierge system.

The online concierge system may select the set of candidate recipes based on product embeddings of the one or more products in the selected products list. For example, the online concierge system may apply a k-nearest neighbors model to recipe embeddings of recipes stored by the online concierge system and the product embeddings of the products on the selected products list to select the set of candidate recipes.

The online concierge system additionally generates a context embedding describing the user's current session with the online concierge system. The online concierge system generates the context embedding by applying a context embedding model to the received context data. The context embedding model may be a neural network trained to generate context embeddings based on context data.

To select a recipe for presentation to the user, the online concierge system scores the set of candidate recipes based on the user embedding, the context embedding, and the recipe embeddings for the set of candidate recipes. The online concierge system may generate an overall score for each of the candidate recipes based on a user score and a context score. The user score for a candidate recipe is a score representing the similarity between the user embedding and a recipe embedding for the candidate recipe. A context score is a score representing the similarity between the context embedding and a recipe embedding for the candidate recipe. In some embodiments, the user score and the context score are calculated based on a cosine similarity score or a dot product of the embeddings used to generate each score. The online concierge system may then select a recipe for presentation to the user based on the overall scores for the candidate recipes.

To train the context embedding model, the online concierge system may apply a loss function to the context embedding model when the user interacts with a presented recipe. The loss function applied to the context embedding model may be based on the average value of the user score and the context score for the recipe selected for presentation to the user.

The online concierge system described herein has several benefits over conventional online systems for presenting content to a user. Using the context embedding model, the online concierge system can more effectively analyze the user's behavior during their current session, thereby allowing the online concierge system to rely less on long-term user data that it has collected and more on the user's current actions, which means the online concierge system may provide content that is better tailored to what the user is currently interested in. Additionally, where the content to be presented to the user is new, the online concierge system's long-term user data is less effective, and the context embedding model allows the online concierge system to focus instead on the user's current actions, which are more likely to be relevant to selecting what of the new content to present to the user.

### BRIEF DESCRIPTION OF DRAWINGS

FIG. 1 illustrates the environment of an online concierge system, according to some embodiments.

FIG. 2 is a block diagram of an online concierge system, according to some embodiments.

FIG. 3A is a block diagram of the user mobile application (UMA), according to some embodiments.

FIG. 3B is a block diagram of the picker mobile application (PMA), according to some embodiments.

FIG. 3C is a block diagram of the runner mobile application (RMA), according to some embodiments.

FIG. 4 is a block diagram for a context modeling module, according to some embodiments.

FIG. 5 illustrates data flow through an example context modeling module, according to some embodiments.

FIG. 6 is a flowchart illustrating an example method for applying a context embedding model to recipe recommendation by an online concierge system, according to some embodiments.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Environment of an Online Concierge System

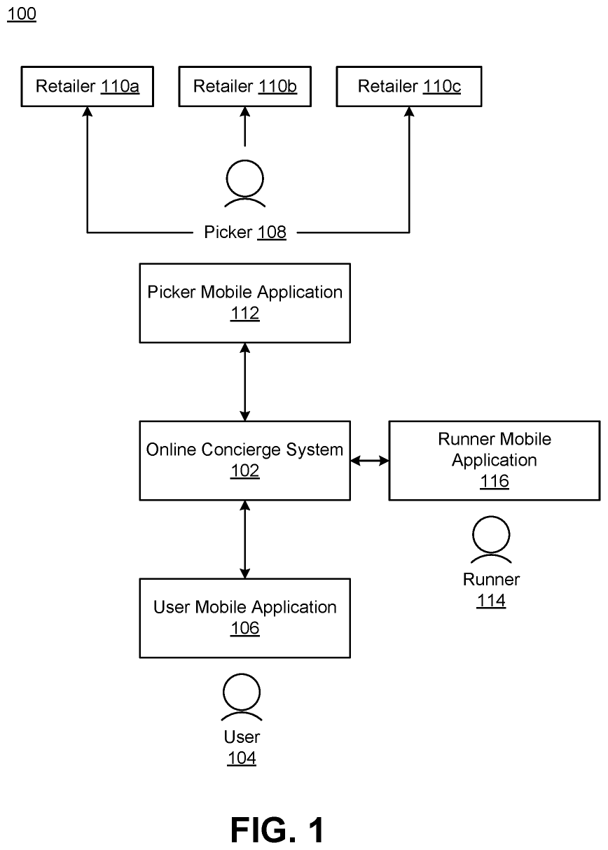

FIG. 1 illustrates the environment 100 of an online concierge system 102, according to some embodiments. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The online concierge system 102 is configured to receive orders from one or more users 104 (only one is shown for the sake of simplicity). An order specifies a list of goods or products to be delivered to the user 104. Goods, items, and products may be used synonymously herein to mean any item that a user 104 can purchase via the online concierge system. The order also specifies the location to which the goods are to be delivered, and a time window during which the goods should be delivered. In some embodiments, the order specifies one or more retailers from which the selected items should be purchased. The user may use a user mobile application (UMA) 106 to place the order; the UMA 106 is configured to communicate with the online concierge system 102.

The online concierge system 102 is configured to transmit orders received from users 104 to one or more pickers 108. A picker 108 may be a contractor, employee, or other person (or entity) who is enabled to fulfill orders received by the online concierge system 102. The environment 100 also includes three retailers 110a, 110b, and 110c (only three are shown for the sake of simplicity; the environment could include any number of retailers). The retailers 110 may be physical retailers, such as grocery stores, discount stores, department stores, etc., or non-public warehouses storing items that can be collected and delivered to users. Each picker 108 fulfills an order received from the online concierge system 102 at one or more retailers 110, delivers the order to the user 104, or performs both fulfillment and delivery. In some embodiments, pickers 108 make use of a picker mobile application 112 which is configured to interact with the online concierge system 102.

### Online Concierge System

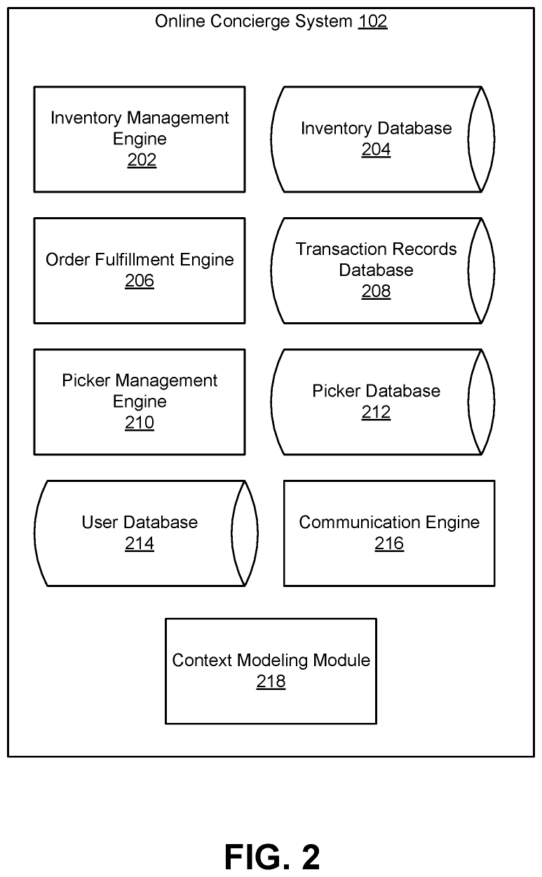

FIG. 2 is a block diagram of an online concierge system 102, according to some embodiments. The online concierge system 102 includes an inventory management engine 202, which interacts with inventory systems associated with each retailer 110. In some embodiments, the inventory management engine 202 requests and receives inventory information maintained by the retailer 110. The inventory of each retailer 110 is unique and may change over time. The inventory management engine 202 monitors changes in inventory for each participating retailer 110. The inventory management engine 202 is also configured to store inventory records in an inventory database 204. The inventory database 204 may store information in separate records—one for each participating retailer 110—or may consolidate or combine inventory information into a unified record. Inventory information includes both qualitative and quantitative information about items, including size, color, weight, SKU, serial number, and so on. In some embodiments, the inventory database 204 also stores purchasing rules associated with each item, if they exist. For example, age-restricted items such as alcohol and tobacco are flagged accordingly in the inventory database 204.

In some embodiments, the inventory database 204 stores product embeddings for products offered for sale on the online concierge system 102. A product embedding is an embedding that describes a product. The product embeddings may be associated with specific products stored by the inventory database 204. For example, each brand of a product may have an individual product embedding, or products may have different product embeddings for each retailer that sells the product. Alternatively, each product embedding may be associated with a generic product, and each generic product is associated with specific products that are similar or substitutes of each other. For example, the inventory database 102 may store a product embedding for the generic product “milk”, and the specific products of “Moo Moo 2% Milk” and “Greener Pastures Organic Whole Milk” may both be associated with the product embedding for “milk.”

The online concierge system 102 also includes an order fulfillment engine 206 which is configured to synthesize and display an ordering interface to each user 104 (for example, via the user mobile application 106). The order fulfillment engine 206 is also configured to access the inventory database 204 in order to determine which products are available at which retailers 110. The order fulfillment engine 206 determines a sale price for each item ordered by a user 104. Prices set by the order fulfillment engine 206 may or may not be identical to in-store prices determined by retailers (which is the price that users 104 and pickers 108 would pay at retailers). The order fulfillment engine 206 also facilitates transactions associated with each order. In some embodiments, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with retailer 110. For example, after successful fulfillment of an order, the order fulfillment engine 206 may transmit a summary of the order to the appropriate retailer. The summary may indicate the items purchased, the total value of the items, and in some cases, an identity of the picker 108 and user 104 associated with the transaction. In some embodiments, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a picker management engine 210, which manages communication with and utilization of pickers 108. In some embodiments, the picker management engine 210 receives a new order from the order fulfillment engine 206. The picker management engine 210 identifies the appropriate retailer 110 to fulfill the order based on one or more parameters, such as the contents of the order, the inventory of the retailers, and the proximity to the delivery location. The picker management engine 210 then identifies one or more appropriate pickers 108 to fulfill the order based on one or more parameters, such as the pickers' proximity to the appropriate retailer 110 (and/or to the user 104), his/her familiarity level with that particular retailer 110, and so on. Additionally, the picker management engine 210 accesses a picker database 212 which stores information describing each picker 108, such as his/her name, rating, previous shopping history, and so on. The picker management engine 210 transmits the list of items in the order to the picker 108 via the picker mobile application 112. The picker database 212 may also store data describing the sequence in which the pickers' picked the items in their assigned orders.

As part of fulfilling an order, the order fulfillment engine 206 and/or picker management engine 210 may access a user database 214 which stores information describing each user. This information could include each user's name, address, gender, shopping preferences, favorite items, stored payment instruments, and so on.

The online concierge system 102 may use a communication engine 216 that transmits information between the user mobile application 106, the picker mobile application 112, and the runner mobile application 116. The information may be sent in the form of messages, such as texts or emails, or notifications via application, among other forms of communication. The communication engine 216 may receive information from each application about the status of an order, the location of a user in transit, issues with items in an order, and the like. The communication engine 216 determines a message or notification to send to a user 104, picker 108, or runner 114 based on this information and transmits the notifications to the appropriate application. For example, the online concierge system 102 may receive information from the user mobile application 106 indicating that a user 104 is traveling to the pickup location to retrieve an order. Based on this information, the communication engine 216 sends a notification to the runner mobile application 116 indicating that the user 104 associated with a specific order is in transit, which may incite the runner 114 to retrieve the order for pick up. In another example, the online concierge system 102 may receive a message from the picker mobile application 112 that an item of an order is not available. The communication engine 216 may transmit the message to the user mobile application 106 associated with the order.

The online concierge system 102 includes a context modeling module 218 that recommends recipes to the user 104 while the user 104 is shopping via the UMA 106. The context modeling module 218 predicts a recipe for which the user 104 is ordering goods and recommends additional goods that the user 104 may want to order to complete the recipe. The context modeling module 218 predicts a recipe recommendation for a user 104 based on information about the user 104, the context within which the user 104 is ordering goods via the UMA 106, and the recipes stored by the online concierge system 102. The context modeling module 218 is discussed in further detail below.

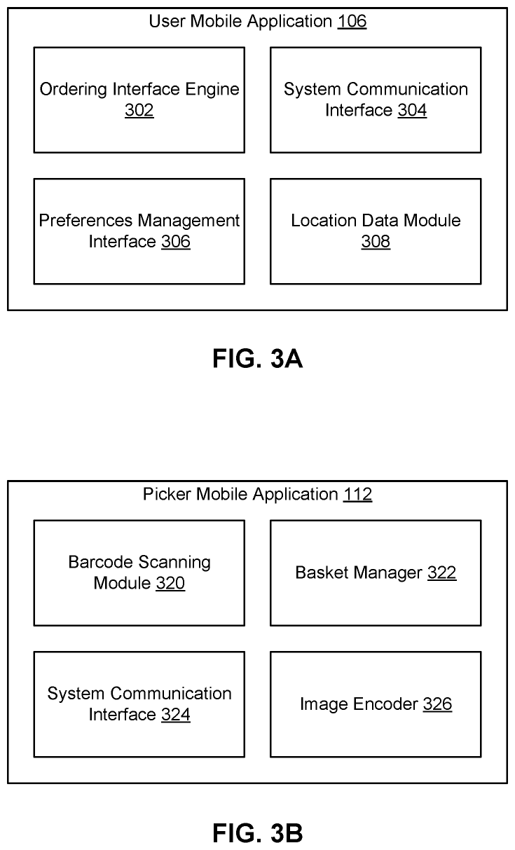

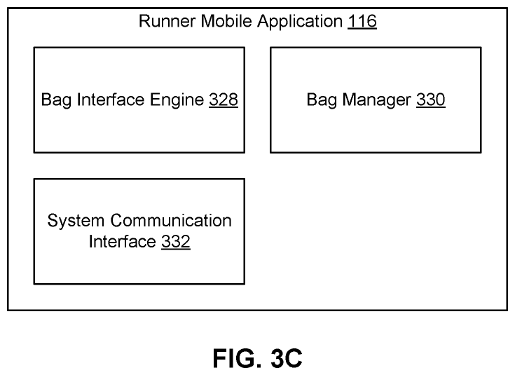

FIG. 3A is a block diagram of the user mobile application (UMA) 106, according to some embodiments. The user 104 accesses the UMA 106 via a client device, such as a mobile phone, tablet, laptop, or desktop computer. The UMA 106 may be accessed through an app running on the client device or through a website accessed in a browser. The UMA 106 includes an ordering interface 302, which provides an interactive interface with which the user 104 can browse through and select products and place an order. The ordering interface 302 also may include a selected products list that specifies the amounts and prices of products that the user 104 has selected to order. The user 104 may review the selected products list and place an order based on the selected products list. Furthermore, the ordering interface 302 may present recipes to the user 104 that the online concierge system 102 predicts the user 104 is attempting to complete, and may provide an option to the user 104 to add additional products needed to complete a recipe to the user's selected products list.

Users 104 may also use the ordering interface 302 to message with pickers 108 and runners 114 and receive notifications regarding the status of their orders. The UMA 106 also includes a system communication interface 304 which, among other functions, receives inventory information from the online concierge system 102 and transmits order and location information to the online concierge system 102. The UMA 106 also includes a preferences management interface 306 which allows the user 104 to manage basic information associated with his/her account, such as his/her home address and payment instruments. The preferences management interface 306 may also allow the user to manage other details such as his/her favorite or preferred retailers 110, preferred handoff times, special instructions for handoff, and so on.

The UMA 106 also includes a location data module 308. The location data module 308 may access and store location data related to a client device associated with a user 104 via the user mobile application 106. Location data may include the geographic location of the client device associated with the user mobile application 106, how fast the client device is travelling, the average speed of the client device when in transit, the direction of travel of the client device, the route the user 104 is taking to a pickup location, current traffic data near the pickup location, and the like. For simplicity, the location of a user client device or client device may be referred to as the location of the user throughout this description. The user 104 may specify whether or not the share this location data with the user mobile application 106 via the preferences management interface 306. If a user 104 does not allow the user mobile application 106 to access their location data, the location data module 308 may not access any location data for the user 104. In some embodiments, the user 104 may specify certain scenarios when the location data module 308 may receive location data, such as when the user 104 is using the user mobile application 106, any time, or when the user 104 turns on location tracking in the user mobile application 106 via an icon. The user 104 may also specify which location data the location data module 308 may retrieve, and which location data is off-limits. In some embodiments, the location data module 308 may be tracking the user's 104 location as a background process while the UMA 106 is in use. In other embodiments, the UMA 106 may use real-time location data from the location data module 308 to display a map to the user 104 indicating their current location and the route to a pickup location for their order.

FIG. 3B is a block diagram of the picker mobile application (PMA) 112, according to some embodiments. The picker 108 accesses the PMA 112 via a mobile client device, such as a mobile phone or tablet. The PMA 112 may be accessed through an app running on the mobile client device or through a website accessed in a browser. The PMA 112 includes a barcode scanning module 320 which allows a picker 108 to scan an item at a retailer 110 (such as a can of soup on the shelf at a grocery store). The barcode scanning module 320 may also include an interface which allows the picker 108 to manually enter information describing an item (such as its serial number, SKU, quantity and/or weight) if a barcode is not available to be scanned. The PMA 112 also includes a basket manager 322 which maintains a running record of items collected by the picker 108 for purchase at a retailer 110. This running record of items is commonly known as a “basket”. In some embodiments, the barcode scanning module 320 transmits information describing each item (such as its cost, quantity, weight, etc.) to the basket manager 322, which updates its basket accordingly. The PMA 112 also includes an image encoder 326 which encodes the contents of a basket into an image. For example, the image encoder 326 may encode a basket of goods (with an identification of each item) into a QR code which can then be scanned by an employee of the retailer 110 at check-out.

The PMA 112 also includes a system communication interface 324, which interacts with the online concierge system 102. For example, the system communication interface 324 receives information from the online concierge system 102 about the items of an order, such as when a user updates an order to include more or less items. The system communication interface may receive notifications and messages from the online concierge system 102 indicating information about an order. The system communication interface transmits notifications and messages to be displayed via a user interface of the mobile deice associated with the PMA 112.

FIG. 3C is a block diagram of the runner mobile application (RMA) 116, according to some embodiments. The runner 114 accesses the RMA 116 via a client device, such as a mobile phone, tablet, laptop, or desktop computer. The RMA 116 may be accessed through an app running on the client device or through a website accessed in a browser. The RMA 116 includes bag interface engine 328, which provides an interactive interface with which the runner 114 can view orders they need to deliver and the locations of the bags for each order, such as on a particular shelf or in a refrigerator of a pickup location. The runner 114 may receive notifications through the bag interface engine 328 about new orders, the location of a user 104 who is in transit to a pickup location, and new orders to deliver. The runner 114 may also receive communications via the bag interface engine 328 with users regarding order handoff and pickup confirmation and may interact with the interface generated by the bag interface engine 328 to send communications to users and the online concierge system 102 regarding order status. For example, a runner 114 may send the user a pickup spot at the pickup location to meet for order handoff and indicate that an order has been delivered to a user via the interface, which ends the wait time calculation by the location data module 308 associated with the user.

The RMA 116 includes a bag manager 330 that manages the assignment of orders to runners 114 and the locations of bags for each order. The RMA 116 also includes a system communication interface 332 which, among other functions, receives inventory information from the online concierge system 102 and transmits order and bag information to the online concierge system 102. The system communication interface may also receive notifications and messages from the online concierge system 102 indicating information about an order. The system communication interface transmits notifications and messages to be displayed via a user interface of the mobile deice associated with the RMA 116.

### Context Modeling and Recipe Recommendation

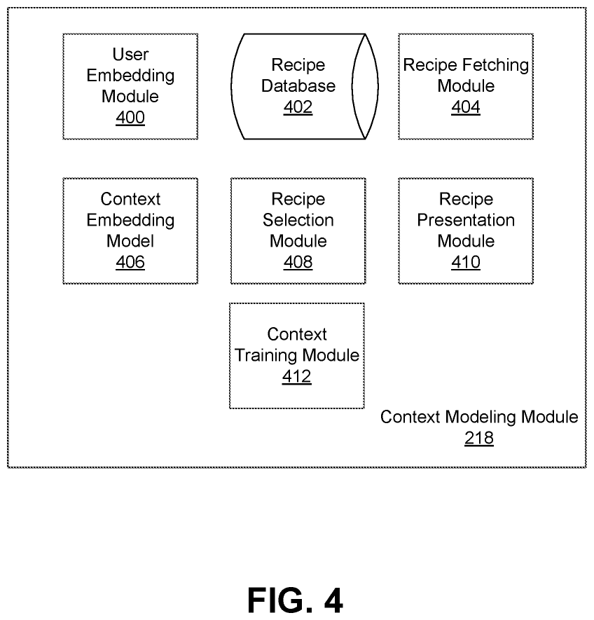

FIG. 4 is a block diagram for a context modeling module 218, according to some embodiments. The context modeling module 218 comprises a user embedding module 400, a recipe database 402, a recipe fetching module 404, a context embedding model 406, a recipe selection module 408, a recipe presentation module 410, and a context training module 412. Alternative embodiments may include more, fewer, or different components from those illustrated in FIG. 4, and the functionality of each component may be divided between the components differently from the description below. Additionally, each component may perform their respective functionalities in response to a request from a human, or automatically without human intervention.

The user embedding module 400 generates user embeddings for users using the online concierge system 102. Each user embedding is an embedding that describes characteristics or features about an associated user. The user embedding module 400 generates user embeddings for a user based on user information stored in the user database 214. The user embedding module 400 may store generated user embeddings in the user database 214 and associate, within the user database 214, each user embedding with a user that the user embedding describes. The user embedding module 400 can also retrieve a user embedding associated with a specified user from the user database 214.

The recipe database 402 stores information about recipes. A recipe is a set of instructions and products that allow a user to produce an end product. For example, a recipe for tomato sauce may include canned tomatoes, basil, garlic, parsley, and olive oil as ingredients and may include instructions for how to turn those ingredients into tomato sauce. The recipe database 402 stores, for each recipe, a set of products that a user can purchase via the online concierge system 102 to complete the recipe. A recipe's set of products may include specific products (e.g., a product from a particular brand or retailer) or generic products. In some embodiments, the recipe database 402 also stores, for each recipe, a product embedding associated with each generic product or specific product in the recipe's set of products.

The recipe database 402 may also store a recipe embedding for each recipe. Recipe embeddings are embeddings that describe recipes stored by the recipe database 402. A recipe embedding for a recipe may be generated by the online concierge system 102 based on the set of products of the recipe, product embeddings associated with the recipe, or instructions required for the user to perform the recipe.

The recipe fetching module 404 selects a set of candidate recipes from the recipe database 402 for possible presentation to the user. The recipe fetching module 404 selects the set of candidate recipes based on context data received from the UMA 106. Context data is information describing the user's current session with the UMA 106. For example, the context data may include search data by the user, data on how long the user has been in the current session, and data describing the user's engagement with search results that have been presented to the user during the session. Context data may also include data about a selected products list that the user has created using the UMA 106. For example, the context data may include which products the user has added to their selected product list. In some embodiments, the context data includes product embeddings for products in the user's selected products list.

To select the set of candidate recipes, the recipe fetching module 404 identifies recipes whose sets of products are similar to the products that are in the user's selected product list. Specifically, the recipe fetching module 404 may compare the product embeddings of the products in the user's selected product list with recipe embeddings of recipes in the recipe database 402. In some embodiments, the recipe fetching module 404 uses a k-nearest neighbors model to identify a set of recipe embeddings that are similar to the product embeddings of the products in the selected products list. The recipe fetching module 404 may then select recipes associated with the set of recipe embeddings as the set of candidate recipes.

The context embedding model 406 generates a context embedding for the user's current session using the UMA 106. The context embedding model 406 generates context embeddings based on context data received from the UMA 106. In some embodiments, the context embedding model 406 comprises a neural network that has been trained by the context training module 412 to generate context embeddings based on contextual data. Training of the context embedding model 406 is discussed in further detail with regards to the context training module 412.

The recipe selection module 408 selects a recipe for presentation to a user based on a user embedding, a context embedding for the user's current session, and a set of candidate recipes. To select a recipe for presentation, the recipe selection module 408 generates a score for each of the candidate recipes based on a context embedding, a user embedding, and the recipe embeddings for the set of candidate recipes. In some embodiments, to generate an overall score for each recipe, the recipe selection module 408 generates a user score and a context score for each recipe. The user score is a score representing the similarity between the user embedding and the recipe embedding for the candidate recipe. The user score may be generated based on a dot product or a cosine-similarity of the user embedding and the recipe embedding for the candidate recipe. The context score is a score representing the similarity between the context embedding and the recipe embedding for the candidate recipe. The context score may be generated based on a dot product or a cosine-similarity of the context embedding and the recipe embedding. In some embodiments, the user score and the context score are each within the range [0,1]. The recipe selection module 408 may generate the overall score for each candidate recipe based on the user score and context score for each candidate recipe. The recipe selection module 408 then selects a recipe of the set of candidate recipes for presentation to the user based on the overall score for each candidate recipe.

The recipe presentation module 410 presents the recipe selected by the recipe selection module 408 to a user via the UMA 106. The recipe presentation module 410 may transmit a message to the UMA 106 with instructions to present a UI with the recipe to the user. The presented UI may include an option for the user to add, to the selected products list, products from the set of products associated with the recipe. In some embodiments, the recipe presentation module 410 presents a recipe recommendation to the user based on a recipe selected by the recipe selection module 408. The recipe recommendation is a recommendation that the user interact with the recipe in some way. For example, the recipe recommendation may recommend that the user view the products associated with the recipe, view the instructions associated with the recipe, or add, to the selected products list, products from the set of products associated with the recipe. The recipe recommendation may include a name of the recommended recipe, a picture of the completed recipe, a description of the recipe, a link to a page describing the recipe, a subset of the products associated with the recipe, or a subset of the instructions associated with the recipe. The recipe presentation module 410 may transmit the recipe recommendation instead of or in addition to the recipe selected by the recipe selection module 408.

The context training module 412 trains the context embedding model 406. The context training module 412 may train the context embedding model 406 using a loss function that is based on the user score and context score for the selected recipe. For example, the loss function L may be determined based on the following formula:

$$L = 1 - \frac{{w}_{US} * US + {w}_{CS} * CS}{{w}_{US} + {w}_{CS}}$$

where US is the user score, CS is the context score, w_{US} is a weight given to the user score, and w_{CS} is a weight given to the context score. To train the context embedding model using the loss function, the context training module 412 applies the loss function when the recipe presentation module 410 presents a recipe to a user and the user interacts with the recipe via the UMA 106. In these cases, the context embedding model should have generated a context embedding such that the user score and context score were near 1. Thus, context training module 412 may use the loss function to train the context embedding model to generate context embeddings that minimize the value of the loss function when a user interacts with a recipe.

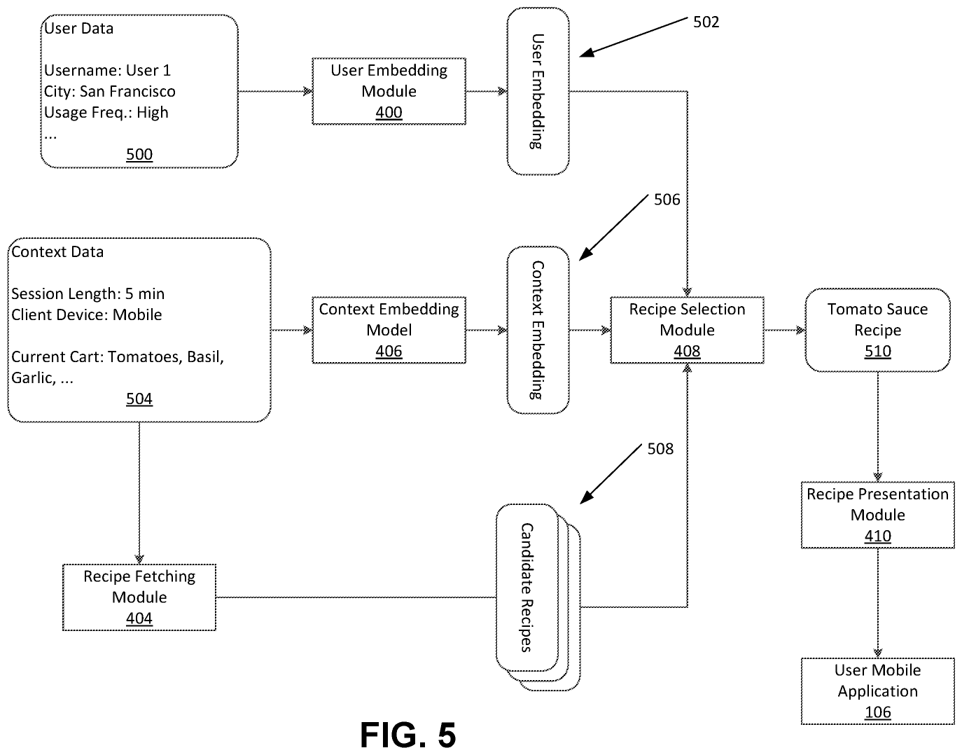

FIG. 5 illustrates data flow through an example context modeling module, according to some embodiments. Alternative embodiments may include more, fewer, or different components from those illustrated in FIG. 5, and the functionality of each component may be divided between the components differently from the description below. Additionally, each component may perform their respective functionalities in response to a request from a human, or automatically without human intervention.

The user embedding module 400 receives user data 500. The user data 500 illustrated in FIG. 5 includes the user's username, where the user is located, and how often the user uses the online concierge system. The user embedding module 400 generates a user embedding 502 based on the user data 500, where the user embedding 502 describes the user data 500.

The context embedding model 404 receives context data 504. The context data 504 includes information about the length of the user's current session, what kind of device the user is currently using to access the UMA 106, and products that are currently in the user's selected products list. The context data 504 may also include information about the user's engagement with search results. The context embedding model 404 generates a context embedding 506 based on the context data 504, where the context embedding 506 describes the context data 504.

The recipe fetching module 402 receives the context data 504 and selects a set of candidate recipes 508 for possible presentation to the user. In some embodiments, the recipe fetching module 402 selects a set of candidate recipes 508 based on product embeddings of the products in the selected product list. The recipe fetching module 402 may use a k-nearest neighbors model to select the set of candidate recipes 508.

The recipe selection module 408 selects a recipe 510 of the set of candidate recipes 508 for presentation to a user via the UMA 106. In the embodiment illustrated in FIG. 5, the selected recipe 510 is a recipe for tomato sauce. The recipe selection module 408 selects the recipe based on the user embedding 502, the context embedding 506 generated by the context embedding model 406, and the recipe embeddings associated with the set of candidate recipes 508 selected by the recipe fetching module 404. The recipe selection module 408 may select the recipe to be presented based on an overall score for each of the candidate recipes. In some embodiments, the overall scores for the candidate recipes are generated based on a user score and a context score. The user score is generated based on the user embedding 502 and the recipe embedding 508 associated with the candidate recipe. The context score is generated based on the context embedding 506 and the recipe embedding associated with the candidate recipe. The user score and the context score may be generated based on a cosine similarity or a dot product of their respective embeddings. The recipe selection module 408 generates an overall score based on the user score and the context score for each candidate recipe, and selects a recipe 510 to be presented to the user based on the overall score of the candidate recipes. In some embodiments, the recipe presentation module 410 transmits the recipe 510 selected by the recipe selection module 408 to the UMA 106 for presentation to the user. The recipe presentation module 410 may transmit a recipe recommendation based on the recipe 510 to the UMA 106 for presentation to the user.

### Applying a Context Embedding Model to Recipe Recommendation

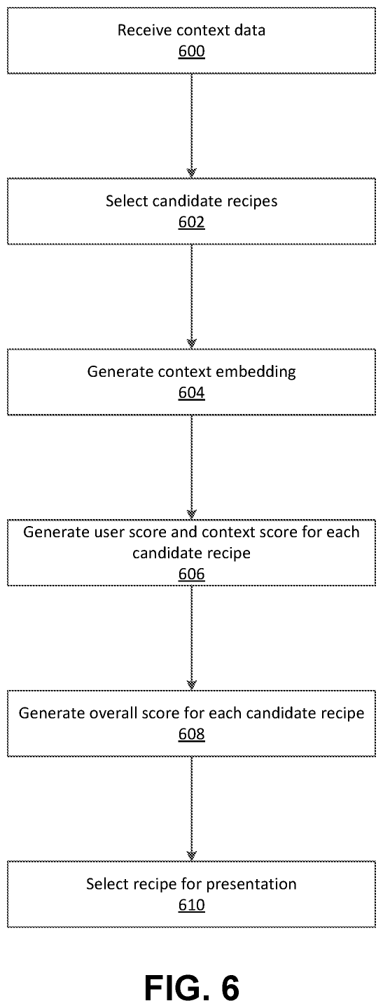

FIG. 6 is a flowchart illustrating an example method for applying a context embedding model to recipe recommendation by an online concierge system, according to some embodiments. Alternative embodiments may include more, fewer, or different steps from those illustrated in FIG. 6, and the steps may be performed in a different order from those illustrated in FIG. 6. Additionally, each of these steps may be performed automatically by the online concierge system with or without human intervention.

The online concierge system receives 600 context data from a user mobile application associated with a user. The context data includes a selected products list which includes one or more products that have been selected by the user. The online concierge system selects 602 a plurality of candidate recipes based on the selected products list, where each of the plurality of candidate recipes is associated with a recipe embedding. In some embodiments, the plurality of candidate recipes are identified based on similarities between the recipe embeddings associated with the candidate recipes and product embeddings associated with products in the selected products list. For example, the online concierge system may apply a k-nearest neighbors model to the recipe embeddings of recipes stored by the online concierge system and the product embeddings associated with products in the selected products list to select the plurality of candidate recipes.

The online concierge system generates 604 a context embedding based on the received context data. The online concierge system generates the context embedding by applying a context embedding model to the context data. The online concierge system generates 606 a user score and a context score for each candidate recipe. The online concierge system generates the user score for a candidate recipe based on a user embedding associated with the user and a recipe embedding associated the candidate recipe. The online concierge system generates the context score for the candidate recipe based on the generated context embedding and the recipe embedding associated with the candidate recipe embedding. The online concierge system then generates 608 an overall score for the candidate recipe based on the user score and context score for the candidate recipe.

The online concierge system selects 610 a recipe for presentation to the user based on the overall scores for the candidate recipes. The online concierge system may then transmit the selected recipe to a UMA for presentation to the user. In some embodiments, the online concierge system transmits a recipe recommendation to a UMA for presentation to the user.

### Other Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

It should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

What is claimed is:

1. A method comprising:
receiving context data from a user mobile application associated with a user, the context data comprising a selected products list including one or more products with which the user has interacted during a current session of the user;
selecting a plurality of candidate recipes based the selected products list, wherein each candidate recipe of the plurality of candidate recipe is associated with a recipe embedding;
generating, using a context embedding model, a context embedding based on the context data, wherein the context embedding describes the current session of the user;
for each candidate recipe embedding:
generating a user score by combining a user embedding associated with the user with a recipe embedding associated with the candidate recipe;
generating a context score by combining the context embedding with the recipe embedding associated with the candidate recipe; and
generating an overall score for the candidate recipe based on the user score and the context score;
selecting a recipe of the plurality of candidate recipes based on the overall scores of each of the plurality of candidate recipes; and
transmitting a recipe recommendation for the selected recipe to the user mobile application for presentation to the user.

2. The method of claim 1, wherein the context data includes search data for the user, data on how long the users has been in the current session, or data describing engagement by the user with search results presented to the user during the current session.

3. The method of claim 1, further comprising:
receiving, from the user mobile application, an interaction by the user with the recipe recommendation for the selected recipe; and
responsive to receiving the interaction, transmitting, to the user mobile application, instructions to include additional products in the selected products list, wherein the additional products comprise products associated with the selected recipe.

4. The method of claim 1, further comprising:
training the context embedding model based on the context data.

5. The method of claim 4, wherein training the context embedding model based on the context data is responsive to receiving, from the user mobile application, an interaction by the user with the selected recipe.

6. The method of claim 5, wherein the context embedding model comprises a neural network.

7. The method of claim 6, wherein training the context embedding model comprises:
applying a loss function to the context data, wherein the loss function is based on the user score and the context score.

8. The method of claim 1, wherein the plurality of candidate recipes are selected based on a similarity of one or more product embeddings of the one or more products of the selected products list and a recipe embedding associated with each candidate recipe of the plurality of candidate recipes.

9. The method of claim 8, wherein selecting the plurality of candidate recipes comprises:
applying a k-nearest neighbors model to the one or more product embeddings and a recipe embedding of each candidate recipe of the plurality of candidate recipes.

10. The method of claim 1, wherein:
the user score is based on a cosine similarity or a dot product of the user embedding and the recipe embedding associated with the candidate recipe; and
the context score is based on a cosine similarity or a dot product of the context embedding and the recipe embedding associated with the candidate recipe.

11. The method of claim 1, wherein the one or more products with which the user interacted comprises one or more products that the user has selected to add to the selected products list.

12. A non-transitory, computer-readable medium comprising instructions that, when executed by a processor, cause the processor to:
receive context data from a user mobile application associated with a user, the context data comprising a selected products list including one or more products with which the user has interacted during a current session of the user;
select a plurality of candidate recipes based the selected products list, wherein each candidate recipe of the plurality of candidate recipe is associated with a recipe embedding;
generate, using a context embedding model, a context embedding based on the context data, wherein the context embedding describes the current session of the user;
for each candidate recipe embedding:
generate a user score by combining a user embedding associated with the user with a recipe embedding associated with the candidate recipe;
generate a context score by combining the context embedding with the recipe embedding associated with the candidate recipe; and
generate an overall score for the candidate recipe based on the user score and the context score;
select a recipe of the plurality of candidate recipes based on the overall scores of each of the plurality of candidate recipes; and
transmit a recipe recommendation for the selected recipe to the user mobile application for presentation to the user.

13. The computer-readable medium of claim 12, wherein the instructions further cause the processor to:
receive, from the user mobile application, an interaction by the user with the selected recipe; and
responsive to receiving the interaction, transmit, to the user mobile application, instructions to include additional products in the selected products list, wherein the additional products comprise products associated with the selected recipe.

14. The computer-readable medium of claim 12, wherein the instructions further cause the processor to:
train the context embedding model based on the context data.

15. The computer-readable medium of claim 14, wherein training the context embedding model based on the context data is responsive to receiving, from the user mobile application, an interaction by the user with the selected recipe.

16. The computer-readable medium of claim 15, wherein the context embedding model comprises a neural network.

17. The computer-readable medium of claim 16, wherein training the context embedding model comprises:
applying a loss function to the context data, wherein the loss function is based on the user score and the context score.

18. The computer-readable medium of claim 12, wherein the plurality of candidate recipes are selected based on a similarity of one or more product embeddings of the one or more products of the selected products list and a recipe embedding associated with each candidate recipe of the plurality of candidate recipes.

19. The computer-readable medium of claim 18, wherein selecting the plurality of candidate recipes comprises:
applying a k-nearest neighbors model to the one or more product embeddings and a recipe embedding of each candidate recipe of the plurality of candidate recipes.

20. The computer-readable medium of claim 12, wherein:
the user score is based on a cosine similarity or a dot product of the user embedding and the recipe embedding associated with the candidate recipe; and
the context score is based on a cosine similarity or a dot product of the context embedding and the recipe embedding associated with the candidate recipe.
